(19) United States
(12) Patent Application Publication
(10) Pub. No.: US 2018/0229262 A1
(43) Pub. Date: Aug. 16, 2018

(54) METHOD FOR SELF-ASSEMBLY OF NANOPARTICLES ON SUBSTRATE

(71) Applicants: AGENCY FOR SCIENCE, TECHNOLOGY AND RESEARCH, Singapore (SG); SINGAPORE UNIVERSITY OF TECHNOLOGY AND DESIGN, Singapore (SG)

(72) Inventors: Mohamed ASBAHI, Singapore (SG); Kwang Wei Joel YANG, Singapore (SG); Junhao TAN, Singapore (SG); Shafigh MEHRAEEN, Singapore (SG); Mei Chee TAN, Singapore (SG)

(21) Appl. No.: 15/748,175

(22) PCT Filed: Jul. 28, 2016
(86) PCT No.: PCT/SG2016/050364

§ 371 Date: Jan. 26, 2018

(30) Foreign Application Priority Data
Jul. 28, 2015 (SG) 10201505884U

(51) Int. Cl. B05D 1/18

(52) U.S. Cl. CPC B05D 1/18

(57) ABSTRACT

The present invention relates to methods for producing a composite material comprising a substrate and a monolayer of nanoparticles self-assembled thereupon, the method comprising: (i) providing a suspension comprising a solvent and nanoparticles dispersed therein; (ii) providing a substrate comprising a surface with void spaces for accommodating said nanoparticles; (iii) contacting one end of said substrate with said suspension in a closed system, to thereby gradually dispose said suspension over said substrate by capillary action, thereby forming a film of suspension on said substrate; and (iv) allowing evaporation of said film of suspension, thereby forming a monolayer of nanoparticles self-assembled in said void spaces on said surface of the substrate. The present invention also relates to composite material produced by the methods disclosed herein.

### TECHNICAL FIELD

The present invention generally relates to a method of producing a composite material comprising a substrate and a monolayer of nanoparticles self-assembled thereupon. The present invention further relates to composite materials produced by such methods.

### BACKGROUND ART

Power saving and high speed computing are among the most challenging tasks expected from the future generation of integrated circuits. Such objectives are currently possible by exploiting the physical properties of existing materials at their nanometer scale. Unfortunately, in plasmonics and spintronics, the damping losses of these properties as well as the interaction distance of their original units may be drastically affected by the size and spacing of these units. One way to overcome these issues is by packing sub-10 nm particles at very high densities in order to reduce the interaction distance between the structures. However, conventional patterning techniques are not able to provide the required quality of the structures at sub-10 nm dimensions due to the multiple fabrication steps (i.e. lithography, etching, etc.) which may affect the resolution at the etching step. On the other hand, while colloidal nanoparticles of many different materials as small as 2 nm in diameter can be easily synthesized then self-assembled to satisfy the above requirements, packing such particles within the desired structures for integration into functional devices is still in its infancy.

Conventional techniques for self-assembly of nanoparticles include Langmuir-Blodgett, drop-coasting, dip-coating and spin-coating. However, there are no significant results regarding directed self-assembly of sub-10 nm particles over large areas.

Another known method is single-particle resolution positioning which is the ability to position chemically-synthesized particles on a solid substrate such that particles are self-assembled in distinct positions instead of assembling in a close-packed manner, which is what commonly happens. Single-particle resolution introduces functionality to nanostructures in an additive process, enabling the incorporation of various cost-effective nanoparticle materials into patterned structures on solid substrates and for the manipulating of particles from solution onto exactly where needed on a surface (e.g. to assemble and integrate nanoparticles into device components). However, although particles can be synthesized with excellent size uniformity in solution, transferring them from solution onto a solid substrate with positioning accuracy towards fabricating a functioning device is extremely challenging as the particles tend to aggregate or assemble in a random fashion. Further, single-particle resolution self-assembly currently has been achieved only with large particles having a diameter of greater than 50 nm. However, at the sub-10 nm dimension, this has yet to be demonstrated because particles are more susceptible to Brownian motion at these length scales and typically assemble in a random manner. Nevertheless, it is an ongoing pursuit to achieve self-assembly with single-particle resolution as logic, memory, and optical devices are quickly approaching this length scale.

There is therefore a need to provide a method to position sub 10-nm particles that overcomes, or at least ameliorates, one or more of the disadvantages described above.

### SUMMARY OF INVENTION

According to a first aspect, there is provided a method of producing a composite material comprising a substrate and a monolayer of nanoparticles self-assembled thereupon, the method comprising:

(i) providing a suspension comprising a solvent and nanoparticles dispersed therein;

(ii) providing a substrate comprising a surface with void spaces for accommodating said nanoparticles;

(iii) contacting one end of said substrate with said suspension in a closed system, to thereby gradually dispose said suspension over said substrate by capillary action, thereby forming a film of suspension on said substrate; and

(iv) allowing evaporation of said film of suspension, thereby forming a monolayer of nanoparticles self-assembled in said void spaces on said surface of the substrate.

Advantageously, the disclosed method may be able to position sub-10 nm particles via self-assembly. Further advantageously, the disclosed method may be able to position sub-10 nm particles with single particle resolution via self-assembly. Advantageously, the disclosed method may not result in the formation of a double layer and may be defect-free.

Further advantageously, the disclosed method may enable self-assembly within both periodic and non-periodic templates over a large area. Moreover, periodic and non-periodic structures may be simultaneously obtained on the same substrate allowing the fabrication of complex nanostructures and patterns.

Advantageously, the disclosed method may be a simple process that is cost-effective with potential for mass production.

Further advantageously, the disclosed method may produce defect-free materials.

Advantageously, the disclosed method may allow for the use of active materials (e.g. quantum dots, magnetic nanoparticles, plasmonic materials) without further fabrication steps.

In a second aspect of the present disclosure, there is provided a method of producing a composite material comprising a substrate and a monolayer of nanoparticles self-assembled thereupon, the method comprising:

(i) providing a suspension comprising a solvent and nanoparticles dispersed therein;

(ii) providing a substrate comprising a surface with void spaces for accommodating said nanoparticles;

(iii) contacting one end of said substrate with said suspension in a closed system, to thereby gradually dispose said suspension over said substrate by capillary action, thereby forming a film of suspension on said substrate; and

(iv) allowing evaporation of said film of suspension, thereby forming a monolayer of nanoparticles self-assembled in said void spaces on said surface of the substrate, wherein each void space accommodates one nanoparticle.

In a third aspect of the present disclosure, there is provided a composite material produced by a method disclosed herein.

### DEFINITIONS

The following words and terms used herein shall have the meaning indicated:

The term “monolayer” as used herein refers to a single layer of nanoparticles coated on substrate.

The term “self-assembled” or “self-assembly” as used herein refers to the self-ordering organization of nanoparticles that occurs spontaneously during evaporation of a film of suspension on a substrate.

The term “sub-10 nm particles” as used herein refers to particles that have diameters in the sub-10 nm range, for example the nanoparticles may have a diameter of about 1 nm, about 2 nm, about 3 nm, about 4 nm, about 5 nm, about 6 nm, about 7 nm, about 8 nm, or about 9 nm.

The term “closed system” as used herein refers to a sealed or otherwise contained system that is selectively isolated from the external environment.

The term “capillary action” as used herein refers to the generation of liquid flow only by virtue of surface tension of the liquid. Such liquid flow can be established without the need to apply mechanical or other force to the liquid, and in the absence of any vector component of the gravitational force in the direction of the flow, and in some situations, in opposition to external forces such as gravity.

The term “film” as used herein refers to a layer of suspension comprising solvent and nanoparticles disposed on a substrate. The term “thin film” as used herein refers to a film having a thickness about 1 to 3 times the diameter of a nanoparticle within the film. The film may have a thickness of about 1.0, 1.25, 1.5, 1.75, 2.0, 2.25, 2.5, 2.75 or 3.0 times the diameter of a nanoparticle within the film. The thickness of the thin film may be just wide enough to accommodate one nanoparticle at a time.

The term “void space” as used herein refers to spaces within the substrate or on the substrate due to the formation of imprint patterns on the substrate's surface. The term “void space” may also be read to encompass terms such as “cavities” and “pores”. The void space may be suitable for accommodating nanoparticles(s) such that a substrate filled with nanoparticles in its void spaces may be referred to as a “composite material”.

The term “volatile” as used herein refers to a boiling point that is less than water and a vapor pressure that is greater than water.

The term “nanohole” as used herein refers to a hole, pore or passage having a nanoscale width.

The term “nanopillar” as used herein refers to a pore or passage or hole with one principle axis that is longer than the other two principle axes, wherein the principle axes are in the nanoscale range.

The term “nanograting” or “nanochannel” as used herein refers to a grating or channel with a cross section having at least one dimension (e.g. height, width, diameter, etc.) in the nanoscale range.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of the present invention will now be disclosed.

The present invention provides a new approach to perform directed self-assembly of nanoparticles particles, such as sub-10 nm particles, with capability of single particle resolution over a large area. This technique takes advantage of the spreading nature of nanofluids (i.e. fluids with suspended nanoparticles) on solid surfaces. In contrast to conventional macroscale meniscus-driven self-assembly methods, the current invention employs a thin film spreading out of the macroscopic meniscus to spread the particles with an equilibrated density over the sample surface. The capability of controlling the particles' registration on the substrate at sub-10 nm resolution provides a critical advantage in manipulating the physical properties of the particles. Functional devices may be fabricated by controlling both the individual properties as well as the collective properties arising from interaction of active particles.

The present disclosure provides a method of producing a composite material comprising a substrate and a monolayer of nanoparticles self-assembled thereupon, the method comprising:

(i) providing a suspension comprising a solvent and nanoparticles dispersed therein;

(ii) providing a substrate comprising a surface with void spaces for accommodating said nanoparticles;

(iii) contacting one end of said substrate with said suspension in a closed system, to thereby gradually dispose said suspension over said substrate by capillary action, thereby forming a film of suspension on said substrate; and

(iv) allowing evaporation of said film of suspension, thereby forming a monolayer of nanoparticles self-assembled in said void spaces on said surface of the substrate.

The closed system may comprise or consist of (i) the suspension comprising a solvent and nanoparticles dispersed therein; (ii) the substrate comprising a surface with void spaces for accommodating said nanoparticles; and (iii) an atmosphere comprising evaporated solvent.

The closed system allows for the creation of a solvent-rich environment which may induce the formation of a thin liquid film of suspension that climbs up the substrate surface. Advantageously, maintaining a solvent-rich environment may reduce the evaporation speed of the solvent, hence suppressing turbulent currents within the liquid thin film which may frustrate the monolayer formation, and may subsequently lead to nucleation of defects in the final structure. This is in contrast to an open system which may increase solvent vapour exchange with the external environment, which may disadvantageously lead to short climbing distance of the film on the substrate, for example, a climbing range of only between 2 to 3 mm maximum.

Contacting one end of the substrate may form a meniscus between the substrate and suspension, said meniscus having an edge where the surface of the substrate and the suspension meet, wherein the suspension is gradually disposed onto the substrate when the edge of the meniscus moves relative to the substrate, thereby forming a film of suspension on said substrate. The movement of the edge of the meniscus relative to the substrate may be a result of capillary action. The film may be a thin film.

The term “gradually disposed” refers to the suspension spreading (or advancing, or climbing) from the bulk suspension onto the substrate. The suspension may gradually dispose (or advance, or climb) onto the substrate as a film. The film may start to dispose (or spread, or climb) onto the substrate surface due to the surface tension gradient taking place in the film interface due to the evaporation of solvent as well as the local variation of nanoparticle density. The film length L(t) advances in time (t) as a function of L(t)˜√t. As the nanoparticles are continuously diffusing from the bath to the film, the sample is preferably kept in contact with the bath for at least one hour to ensure a sufficient nanoparticle density within the film to cover the entire free space allocated within the substrate. A depiction of this may be found in FIGS. 1a, 1b and 1c.

The film may be a thin film in the micrometer or nanometer range. The thin film may have a thickness of about 1 to about 3 times the diameter of a nanoparticle within the film. The thickness of the thin film may be just wide enough to accommodate one nanoparticle at a time.

The method of the present invention may create a monolayer of the nanoparticles very close to the substrate surface due to the confinement of the particles within the thin-film thickness. Advantageously, the thin film may facilitate the formation of a monolayer of the nanoparticles by keeping the nanoparticles close to the substrate surface. In contrast, a thicker film may not result in a monolayer of the nanoparticles as van der Walls forces may push away (or repel) the nanoparticles from the substrate surface.

The meniscus that forms between the substrate and suspension at this stage may be a micro-meniscus (i.e. a meniscus in the micrometer size range). The edge of the micro-meniscus may move relative to the substrate, thereby gradually disposing the suspension onto the substrate. The movement of the micro-meniscus relative to the substrate may also refer to the “spreading”, or “climbing” of the suspension onto the substrate and may be via capillary action.

The end of the substrate that is in contact with the suspension may be the bottom end of the substrate. The word “bottom end” refers to the lowest point of the substrate when the substrate is in a substantially vertical position (i.e. at a substantially 90° angle). In this embodiment, the substrate is substantially perpendicular relative to the suspension and the bottom end of the substrate is in contact with the suspension. When in contact with the suspension, the suspension may gradually dispose (or advance, or climb) onto the substrate, thereby forming a film of suspension on said substrate.

In other embodiments, the substrate may be at an angle relative to the suspension, for example at an about 45° to about 90° angle relative to the suspension. In this embodiment, the “bottom end” of the substrate refers to the lowest point of the substrate. The angle of the substrate relative to the suspension may affect the thickness of the thin climbing film and therefore the angle of the substrate relative to the suspension may be adjusted according to the desired thickness of thin film. For example, the higher the desired thickness of thin film, the lower the angle of the substrate relative to the suspension. The angle of the substrate relative to the suspension may also be adjusted according to the density (or number) of cavities (or void spaces) on the substrate. For example, the higher the density of the cavities on the substrate, the higher the angle of the substrate relative to the suspension.

The angle of the substrate may be about 45° relative to the suspension, or about 50° relative to the suspension, or about 55° relative to the suspension, or about 60° relative to the suspension, or about 65° relative to the suspension, or about 75° relative to the suspension, or about 80° relative to the suspension, or about 85° relative to the suspension, or about 90° relative to the suspension.

The suspension gradually disposes onto the substrate until there is sufficient nanoparticle density within the film to cover the entire free space allocated within the substrate. Uniform evaporation of the solvent may then occur which thins the film of suspension disposed on the substrate. The thinning of the film may confine the nanoparticles into a monolayer. This step is depicted in FIG. 1d.

Further evaporation of the solvent may result in the formation of a meniscus between the substrate and suspension, said meniscus having an edge where the surface of the substrate and suspension meet, wherein the monolayer of nanoparticles self-assembled in the void spaces is formed when the edge of the meniscus moves relative to the substrate and pushes the nanoparticle(s) into a void space. The meniscus may take place at the front line of the thin liquid film with the substrate. Solvent evaporation within the thin film may be suppressed due to the van der Walls forces at the liquid-solid interface which increase inversely with film thickness. Consequently, the liquid at this stage enters a drying regime which takes place at the nanomeniscus which may wipe the substrate and push the nanoparticles into the template cavities or void spaces.

The meniscus that forms between the substrate and suspension at this stage may be a nano-meniscus (i.e. a meniscus in the nanometer size range). The width of the nano-meniscus is such that it may accommodate only one nano-particle. The edge of the nano-meniscus may move relative to the substrate, the force of which pushes the nanoparticle into a void space, thereby forming a monolayer of nanoparticles self-assembled in the void spaces. This step is depicted in FIG. 1e.

The substrate may comprise or consist of a surface with void spaces such that each void space may accommodate one nanoparticle or a plurality of nanoparticles. The number of nanoparticles that can be accommodated in each void space depends on the size of the void space and is not particularly limited except that the nanoparticles should form as a monolayer on the substrate. The void can thus accommodate at least one nanoparticle.

The void spaces on the substrate may be due to the formation of nanoholes, nanopillars, nanogratings, nanochannels, or combinations thereof on the substrate. Hence, the substrate may be regarded as a nano-template or a substrate that is patterned with a number of nano-imprints. Where the substrate is imprinted with nano-holes, the nano-holes are regarded as the void spaces. Where the substrate is imprinted with the nanopillars, the area surrounded by at least two nano-pillars can be regarded as a void space. Where the substrate is imprinted with nanogratings or nanochannels (with corresponding nanobanks in between), the space between the nanogratings (or nanochannels) or the nanobanks can be regarded as a void space. As such, the void spaces on the substrate may be selected from the group consisting of nanoholes, the space between nanopillars, the space between nanogratings, the space between nanochannels, and combinations thereof.

The number of particles per void space may be determined by the packing fraction which is defined as the ratio of the surface occupied by the particles and the surface area of the void space. Therefore, in an embodiment where the substrate comprises nanogratings, the spacing between the nanogratings may be commensurate with the nanoparticles lattice and an integer of particle lines may be packed with a constant packing fraction. However, between one line of particles and two lines of particles between the nanogratings will pass by a transition regime if the spacing between the nanogratings is large enough for 1.5 particle diameter. This would mean that the particles in this case may pack in a zig-zag fashion with variable packing fraction.

The length, width and/or depth of each void space may be proportional to the nanoparticle size. For example, the length, width and/or depth of each void space may be 1.1 to 1.9 times the average diameter of the nanoparticles. The length, width and/or depth of each void space may be adjusted to 1.1 to 1.9 times the average diameter of the nanoparticles in order to avoid double occupation of the void spaces, therefore forming a monolayer of nanoparticles. For example, in an embodiment where the nanoparticle has a diameter of 8 nm, the length, width and/or depth of each void space may be in the range of about 10 to 15 nm. In another embodiment where the nanoparticle has a diameter of 9 nm, the length, width and/or depth of each void space may be in the range of about 10 nm to about 17 nm.

The length, width and/or depth of each void space may be adjusted to about 1.1 times the average diameter of the nanoparticles, or about 1.15 times, about 1.2 times, about 1.25 times, about 1.3 times, about 1.35 times, about 1.4 times, about 1.45 times, about 1.5 times, about 1.55 times, about 1.60 times, about 1.65 times, about 1.70 times, about 1.75 times, about 1.80 times the diameter, about 1.85 times, or about 1.90 times the average diameter of the nanoparticles.

In an embodiment where the nanoparticle size is 8 nm or 9 nm, the length, width and/or depth between each void space may be in the range of about 10 nm to about 15 nm, for example, about 10 nm, about 11 nm, about 12 nm, about 13 nm, about 14 nm, or about 15 nm.

The length of the filled space between each void space may be at least 1 nm, or at least 5 nm, at least 10 nm, at least 15 nm, at least 20 nm, or upwards.

The substrate may comprise or consist of a surface with void spaces wherein each void space is pre-defined. Each pre-defined void space may accommodate one nanoparticle or a plurality of nanoparticles. The number of nanoparticles that can be accommodated in each void space depends on the size of the void space and is not particularly limited except that the nanoparticles should form as a monolayer on the substrate. The void can thus accommodate at least one nanoparticle.

The void spaces on the substrate may be pre-defined by forming imprint patterns on the substrate. The imprint patterns may be formed using any existing top-down patterning techniques such as lithography, electron beam lithography, focused ion beam or nanoimprint. The pre-defined void spaces may be specially configured based on the type of nanoparticle(s) it is intended to accommodate.

The pre-defined void spaces may be arranged in a periodic manner. Alternatively, the pre-defined void spaces may be arranged in a non-periodic manner. The substrate may comprise or consist of periodic and non-periodic void spaces. Hence, the substrate may have the same type of imprint patterns thereon, or may have a different type of imprint patterns thereon. Where the same type of imprint pattern is used, the dimension of the imprint pattern may differ from other imprint patterns as well.

The nanoparticles may be any nanoparticle that is capable of being suspended in solvent and may be selected from the group consisting of carbon nanoparticles, silica nanoparticles, metal nanoparticles (such as gold, silver, copper, platinum, palladium, ruthenium, iron, titanium, nickel, or rhenium nanoparticles), metal oxide nanoparticles (such as zinc oxide nanoparticles), quantum dots, magnetic nanoparticles, and plasmonic materials.

The suspension may contain one type of nanoparticle, or may contain two different types of nanoparticles, or may contain three different types of nanoparticles, or may contain four different types of nanoparticles.

The nanoparticles may have a diameter of about 1 nm to about 20 nm, for example about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, or about 20 nm. In a preferred embodiment, the nanoparticles may have diameters in the sub-10 nm range, for example the nanoparticles may have a diameter of about 1 nm, about 2 nm, about 3 nm, about 4 nm, about 5 nm, about 6 nm, about 7 nm, about 8 nm, or about 9 nm.

The substrate may be any supporting structure that is capable of being wetted by solvent, for example the substrate may be selected from the group consisting of Si, Si₃N₄, SiO₂, insulators, semiconductors, glasses, polymers, and metals.

The substrate may be dry or pre-wetted prior to contact with the suspension. In a preferred embodiment, the substrate is dry (i.e. not pre-wetted) prior to contact with the suspension. This is in contrast to other techniques which may require a wet surface in order for the suspension to climb onto the substrate. Advantageously, the method of the present invention may allow the suspension to climb or spread directly from the bulk suspension onto dry substrate.

The solvent may be any solvent that is volatile. For the solvent to climb (or dispose) onto the substrate, the solvent may be evaporative and not heavy. This may create a surface tension gradient in the thin film which climbs on the substrate. The solvent may be selected from the group consisting of organic solvents, alcohols (such as ethanol), aliphatic hydrocarbons, glycol ethers, chlorofluorocarbons, chlorocarbons, benzene, methylene chloride, perchloroethylene, formaldehyde, triethyleamine, toluol, acetaldehyde, pentane, hexane, toluene, benzene, ether, 1,2-dichlorobenzene, acetone, dichloromethane, ethylacetate and combinations thereof. The solvent may not be water.

In one embodiment of the disclosed method, the substrate may be withdrawn or removed from the suspension prior to step (iv). This is depicted in FIG. 1c. Where the substrate is withdrawn or removed from the suspension, the orientation of the withdrawn (or removed) substrate (as compared to when immersed in the suspension) is left relatively unchanged so as to promote the movement of the nanoparticles across the surface of the substrate.

The concentration of nanoparticles in the suspension may be about 1.10×10¹³ cm⁻³ to about 1.99×10¹³ cm⁻³. Alternatively, in the case of lower concentrations, the substrate may be maintained in the suspension for a longer period of time to allow for a sufficient number of nanoparticles to accumulate in the thin climbing film. Advantageously, the concentrations of 1.10×10¹³ cm⁻³ to about 1.99×10¹³ cm⁻³ may provide efficiency to the present method as the substrate may not have to be maintained in the suspension for a prolonged period of time. In some embodiments, the suspension may be maintained in the suspension for about 15 to 75 minutes.

The concentration of nanoparticles in the suspension may be about 1.10×10¹³ cm⁻³, or about 1.15×10¹³ cm⁻³, or about 1.20×10¹³ cm⁻³, or about 1.25×10¹³ cm⁻³, or about 1.30×10¹³ cm⁻³, or about 1.35×10¹³ cm⁻³, or about 1.40×10¹³ cm⁻³, or about 1.45×10¹³ cm⁻³, or about 1.50×10¹³ cm⁻³, or about 1.55×10¹³ cm⁻³, or about 1.60×10¹³ cm⁻³, or about 1.65×10¹³ cm⁻³, or about 1.70×10¹³ cm⁻³, or about 1.75×10¹³ cm⁻³, or about 1.80×10¹³ cm⁻³, or about 1.85×10¹³ cm⁻³, or about 1.90×10¹³ cm⁻³, or about 1.95×10¹³ cm⁻³. The concentration of the nanoparticles may be 1.67×10¹³ cm⁻³.

The substrate may be maintained in the suspension for about 30 to about 75 minutes prior to withdrawal. The substrate may be maintained in the suspension for about 30 minutes, about 35 minutes, about 40 minutes, about 45 minutes, about 50 minutes, about 55 minutes, about 60 minutes, about 65 minutes, about 70 minutes, or about 75 minutes.

In one embodiment of the method of the present invention, the substrate is Si, Si₃N₄, or SiO₂; the suspension comprises or consists of hexane solvent and gold nanoparticles of less than 10 nm diameter dispersed therein; and a substrate comprising a surface with pre-defined void spaces having a length, width and depth of about 10 nm.

There is also provided a method of producing a composite material comprising a substrate and a monolayer of nanoparticles self-assembled thereupon, the method comprising:

(i) providing a suspension comprising a solvent and nanoparticles dispersed therein;

(ii) providing a substrate comprising a surface with void spaces for accommodating said nanoparticles;

(iii) contacting one end of said substrate with said suspension in a closed system, to thereby gradually dispose said suspension over said substrate by capillary action, thereby forming a film of suspension on said substrate; and

(iv) allowing evaporation of said film of suspension, thereby forming a monolayer of nanoparticles self-assembled in said void spaces on said surface of the substrate, wherein each void space accommodates one nanoparticle.

There is also provided a method of producing a composite material comprising a substrate and a monolayer of nanoparticles self-assembled thereupon, the method comprising:

(i) providing a suspension comprising a solvent and nanoparticles dispersed therein;

(ii) providing a substrate comprising a surface with void spaces for accommodating said nanoparticles;

(iii) contacting one end of said substrate with said suspension in a closed system, to thereby gradually dispose said suspension over said substrate by capillary action, thereby forming a film of suspension on said substrate; and

(iv) allowing evaporation of said film of suspension, thereby forming a monolayer of nanoparticles self-assembled in said void spaces on said surface of the substrate, wherein the length, width and/or depth of each void space is 1.1 to 1.9 times the average diameter of the nanoparticles.

There is also provided a method of producing a composite material comprising a substrate and a monolayer of nanoparticles self-assembled thereupon, the method comprising:

(i) providing a suspension comprising a solvent and nanoparticles dispersed therein;

(ii) providing a substrate comprising a surface with void spaces for accommodating said nanoparticles;

(iii) contacting one end of said substrate with said suspension in a closed system, to thereby gradually dispose said suspension over said substrate by capillary action, thereby forming a film of suspension on said substrate;

(iiia) withdrawing the substrate from the suspension; and

(iv) allowing evaporation of said film of suspension, thereby forming a monolayer of nanoparticles self-assembled in said void spaces on said surface of the substrate.

There is also provided a method of producing a composite material comprising a substrate and a monolayer of nanoparticles self-assembled thereupon, the method comprising:

(i) providing a suspension comprising a solvent and nanoparticles dispersed therein;

(ii) providing a substrate comprising a surface with void spaces for accommodating said nanoparticles;

(iii) contacting one end of said substrate with said suspension in a closed system, to thereby gradually dispose said suspension over said substrate by capillary action, thereby forming a film of suspension on said substrate; and

(iiia) withdrawing the substrate from the suspension; and

(iv) allowing evaporation of said film of suspension, thereby forming a monolayer of nanoparticles self-assembled in said void spaces on said surface of the substrate, wherein each void space accommodates one nanoparticle.

There is also provided a method of producing a composite material comprising a substrate and a monolayer of nanoparticles self-assembled thereupon, the method comprising:

(i) providing a suspension comprising a solvent and nanoparticles dispersed therein;

(ii) providing a substrate comprising a surface with void spaces for accommodating said nanoparticles;

(iii) contacting one end of said substrate with said suspension in a closed system, to thereby gradually dispose said suspension over said substrate by capillary action, thereby forming a film of suspension on said substrate; and

(iiia) withdrawing the substrate from the suspension; and

(iv) allowing evaporation of said film of suspension, thereby forming a monolayer of nanoparticles self-assembled in said void spaces on said surface of the substrate, wherein each void space accommodates one nanoparticle, wherein the length, width and/or depth of each void space is 1.1 to 1.9 times the average diameter of the nanoparticles.

There is also provided a method of producing a composite material comprising a substrate and a monolayer of nanoparticles self-assembled thereupon, the method comprising:

(i) providing a suspension comprising a solvent and nanoparticles dispersed therein;

(ii) providing a substrate comprising a surface with void spaces for accommodating said nanoparticles;

(iii) contacting one end of said substrate with said suspension in a closed system, wherein evaporation of said solvent induces spreading of said suspension onto the substrate, thereby forming a thin film of suspension on said substrate; and

(iv) allowing evaporation of said thin film of suspension, thereby forming a monolayer of nanoparticles self-assembled in said void spaces on said surface of the substrate.

The present invention further relates to a composite material produced by a method as disclosed herein.

The method of the present invention may ultimately result in nanoparticles trapped in the void spaces of the substrate via self-assembly. The disclosed method may ultimately result in nanoparticles trapped in the void space(s) of the substrate via self-assembly with single particle resolution. The nanoparticles may be in the sub-10 nm size range. The disclosed method may be not result in the formation of a double layer and may be defect-free. This is depicted in FIG. 1f.

A defect free composite material obtained by the present method is depicted in FIGS. 2(a2), 2(b2) and FIG. 5. This is in contrast to other methods which may form double-layers and have defects, as depicted in FIG. 3.

The method of the present invention may result in spontaneous positioning of single nanoparticles filling single void spaces instead of aggregating or close-packing. The spontaneous position of the nanoparticles may be achieved by the formation and drying of a thin climbing film on the surface of the substrate.

The thin climbing film may result in the ability to control particle positioning as it slows for a uniform spreading of the nanoparticles on the sample surface which leads to a more complete coverage of nanoparticles and a controlled “sweeping” of nanoparticles into the void spaces as the film is allowed to dry in a controlled solvent rich environment.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 illustrates an embodiment of the method disclosed herein. Photographs of the sample taken at different moments of the process are exhibited on the right-side of each step of the process.

FIG. 2 is a number of Scanning Electron Micrograph (SEM) images showing square nanoholes (a1) and nanopillars (b1) templates fabricated by electron beam lithography using Hydrogen Silsesquioxane (HSQ) resist. FIGS. 2(a2) and 2(b2) show the corresponding SEMs after the deposition of 8-9 nm gold nanoparticles by the spreading mediated directed self-assembly method of the present invention.

FIG. 3 is a SEM image showing a monolayer of 8-9 nm gold nanoparticles deposited on both patterned area (left side) and flat area (right side) using the Langmuir-Blodgett method. The bright spots are the excess gold nanoparticles forming a double layer on top of the structures.

FIG. 4 illustrates the Langmuir-Blodgett method.

FIG. 5 is a SEM image showing a large area square nanoholes template fabricated by electron beam lithography using HSQ resist where 8-9 nm diameter gold nanoparticles have been deposited by the spreading mediated directed self-assembly technique of the present invention. The inset at the bottom left corner reveals the structures at a higher magnification.

FIG. 6A illustrates a Brownian dynamics simulation of the directed self-assembly of nanoparticles of the present invention performed on a substrate with a 15 nm film thickness of suspension, 8-9 nm diameter gold nanoparticles, and wherein the substrate is in contact with the suspension at a 10 degree angle (V: Vacancy; S: Singly Occupied; D: Doubly Occupied).

FIG. 6B illustrates a Brownian dynamics simulation of the directed self-assembly of nanoparticles of the present invention performed on a substrate with a 15 nm film thickness of suspension, 8-9 nm diameter gold nanoparticles, and wherein the substrate was in contact with the suspension at a 30 degree angle (V: Vacancy; S: Singly Occupied; D: Doubly Occupied).

FIG. 6C illustrates a Brownian dynamics simulation of the directed self-assembly of nanoparticles of the present invention performed on a substrate with a 15 nm film thickness of suspension, 8-9 nm diameter gold nanoparticles, and wherein the substrate was in contact with the suspension at a 50 degree angle (V: Vacancy; S: Singly Occupied; D: Doubly Occupied).

FIG. 6D illustrates a Brownian dynamics simulation of the directed self-assembly of nanoparticles of the present invention performed on a substrate with a 30 nm film thickness of suspension, 8-9 nm diameter gold nanoparticles, and wherein the substrate was in contact with the suspension at a 10 degree angle (V: Vacancy; S: Singly Occupied; D: Doubly Occupied).

FIG. 6E illustrates a Brownian dynamics simulation of the directed self-assembly of nanoparticles of the present invention performed on a substrate with a 30 nm film thickness of suspension, 8-9 nm diameter gold nanoparticles, and wherein the substrate was in contact with the suspension at a 30 degree angle (V: Vacancy; S: Singly Occupied; D: Doubly Occupied).

FIG. 6F illustrates a Brownian dynamics simulation of the directed self-assembly of nanoparticles of the present invention performed on a substrate with a 30 nm film thickness of suspension, 8-9 nm diameter gold nanoparticles, and wherein the substrate was in contact with the suspension at a 50 degree angle (V: Vacancy; S: Singly Occupied; D: Doubly Occupied).

### DETAILED DESCRIPTION OF DRAWINGS

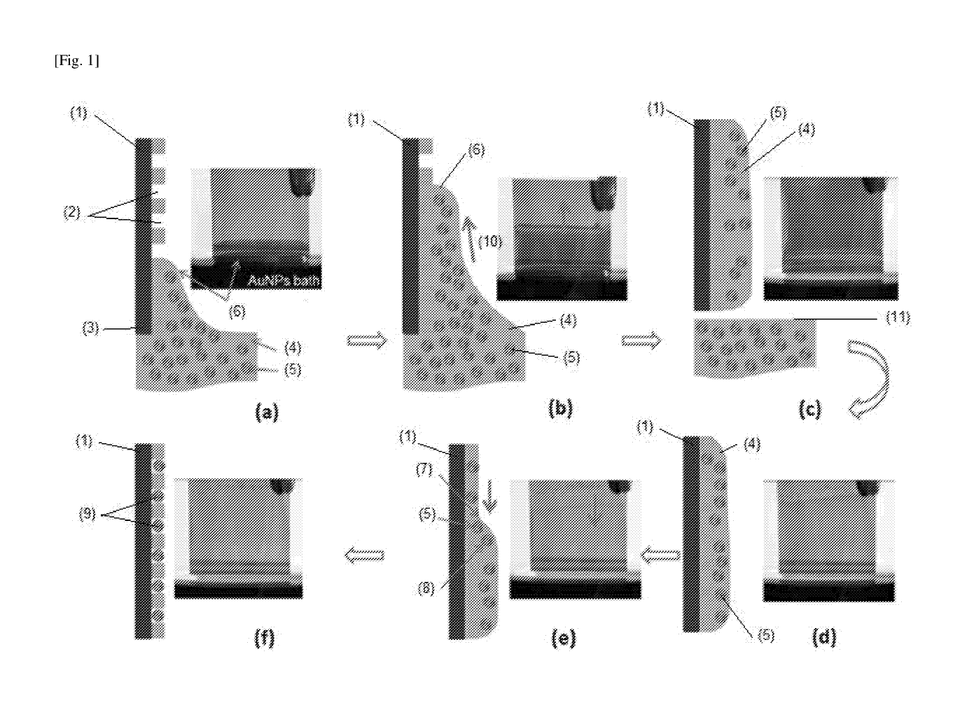

FIG. 1 shows an embodiment of the present spreading mediated directed self-assembly process. In step (a), the bottom surface (3) of a nanopatterned substrate (1) with void spaces (2) is brought into contact with a suspension of nanoparticles (5) and solvent (4). Upon contact with the suspension, a micro-meniscus (6) is formed. Step (b) shows a layer of nanoparticles film (10) climbing up and spreading on the substrate (1) from a micro-meniscus (6). In step (c), the substrate (1) is lifted above the surface of the suspension (11) and step (d) shows the film thinning due to uniform evaporation of solvent which confines the nanoparticles (5) into a monolayer. Step (e) shows the formation of a nano-meniscus (7) that pushes the nanoparticles (5) into the void spaces (2) and sweeps away the excess nanoparticles (8) while the film is drying. Step (f) shows nanoparticles trapped within the void spaces (9) of the substrate (1) with single particle resolution.

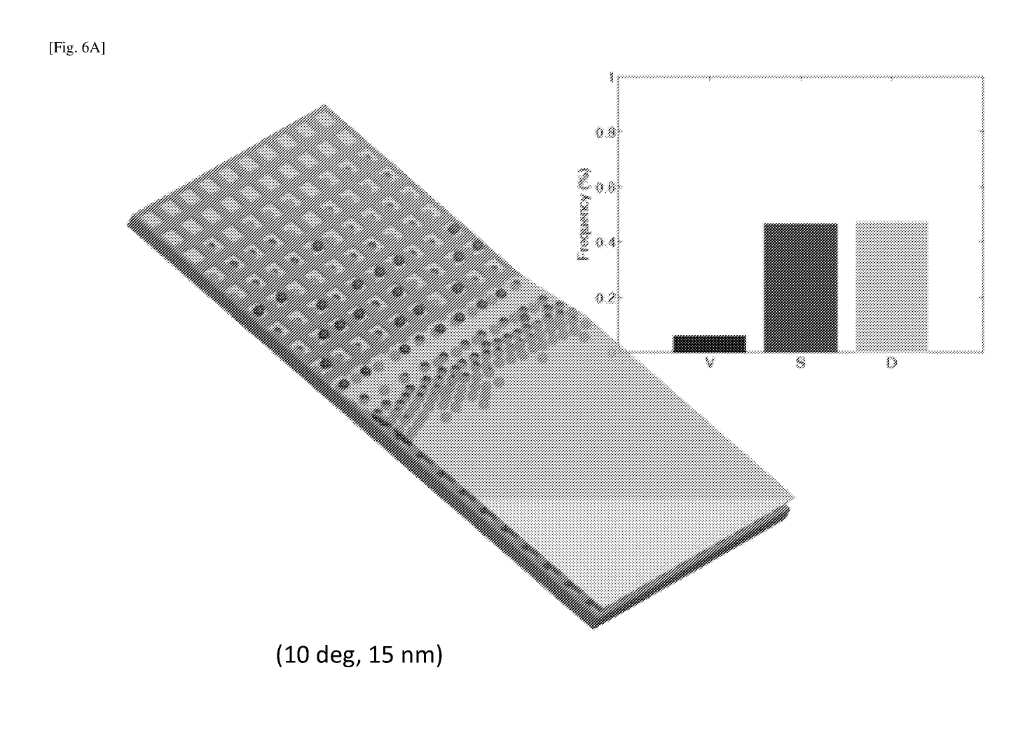

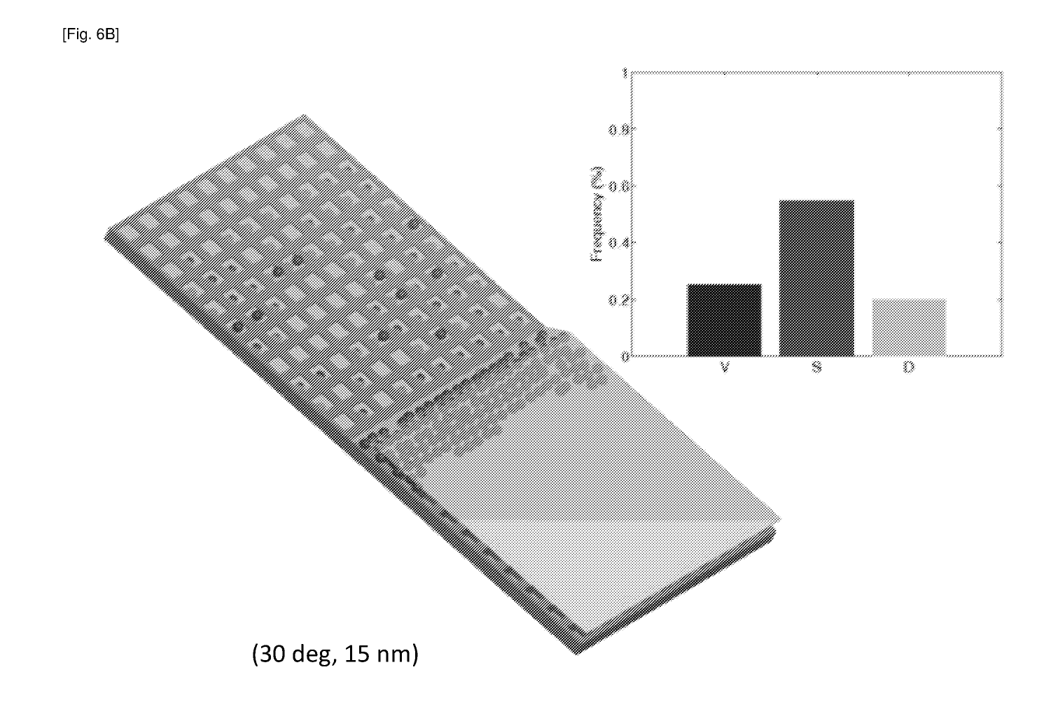

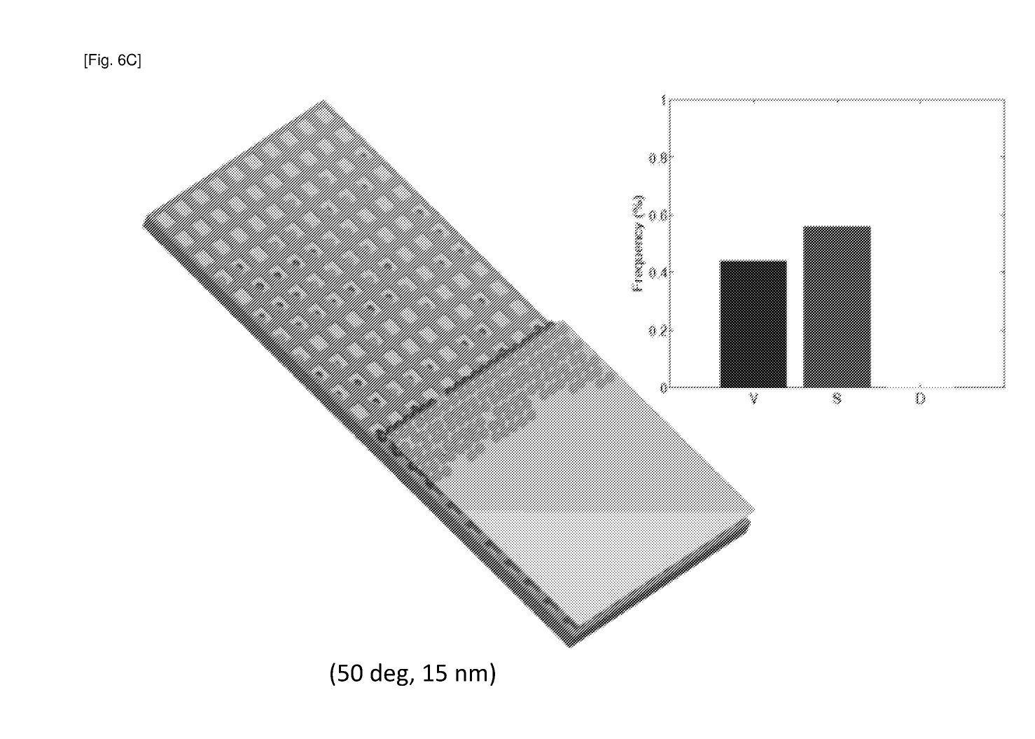

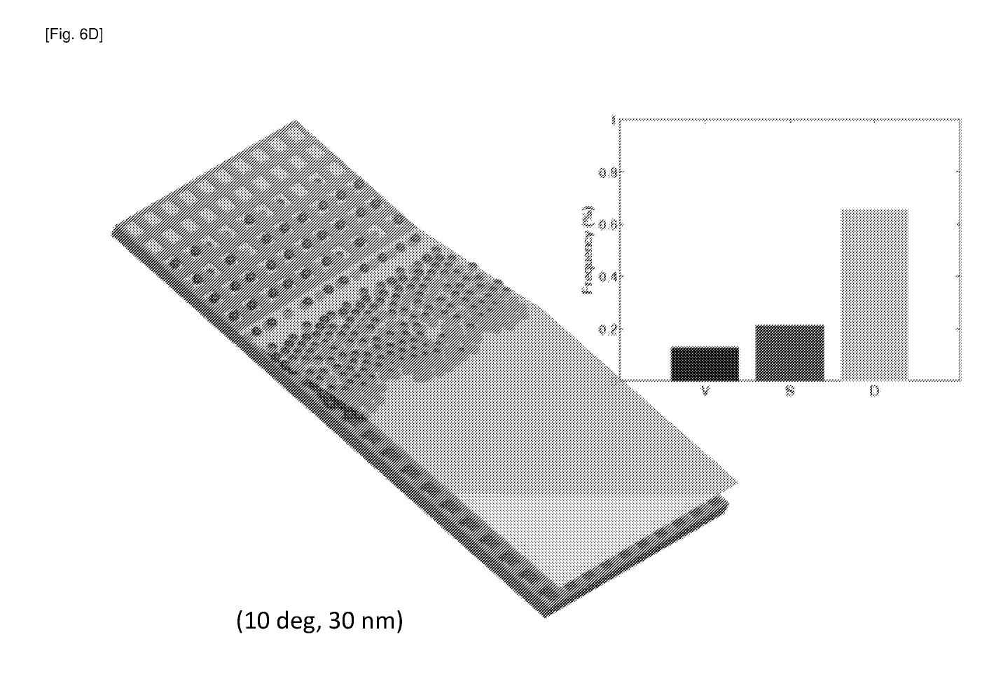

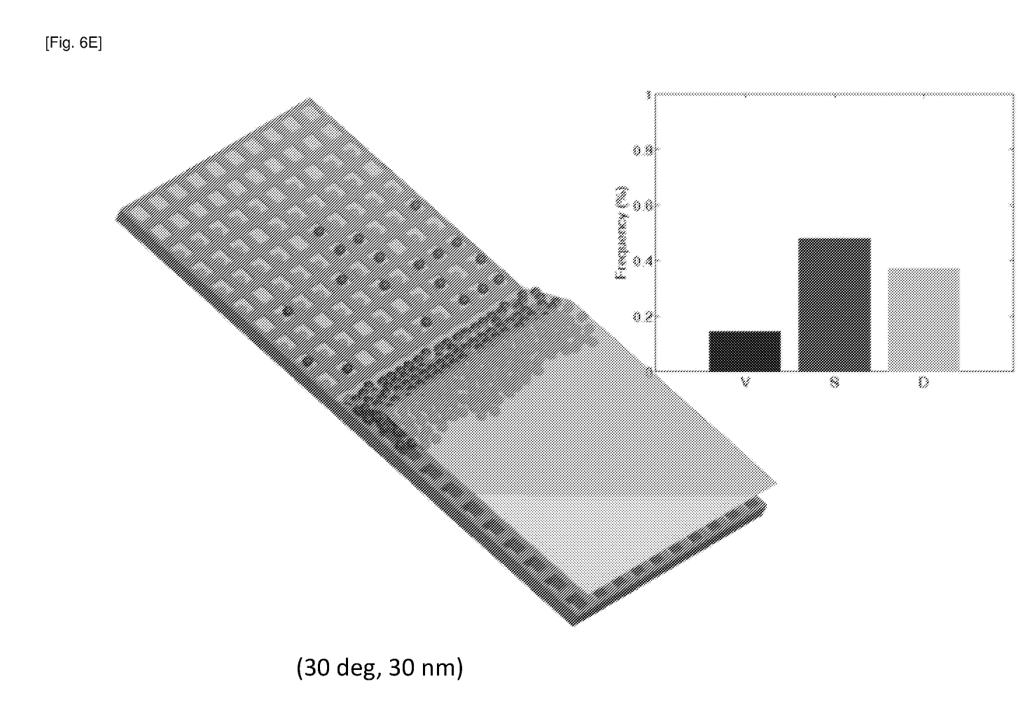

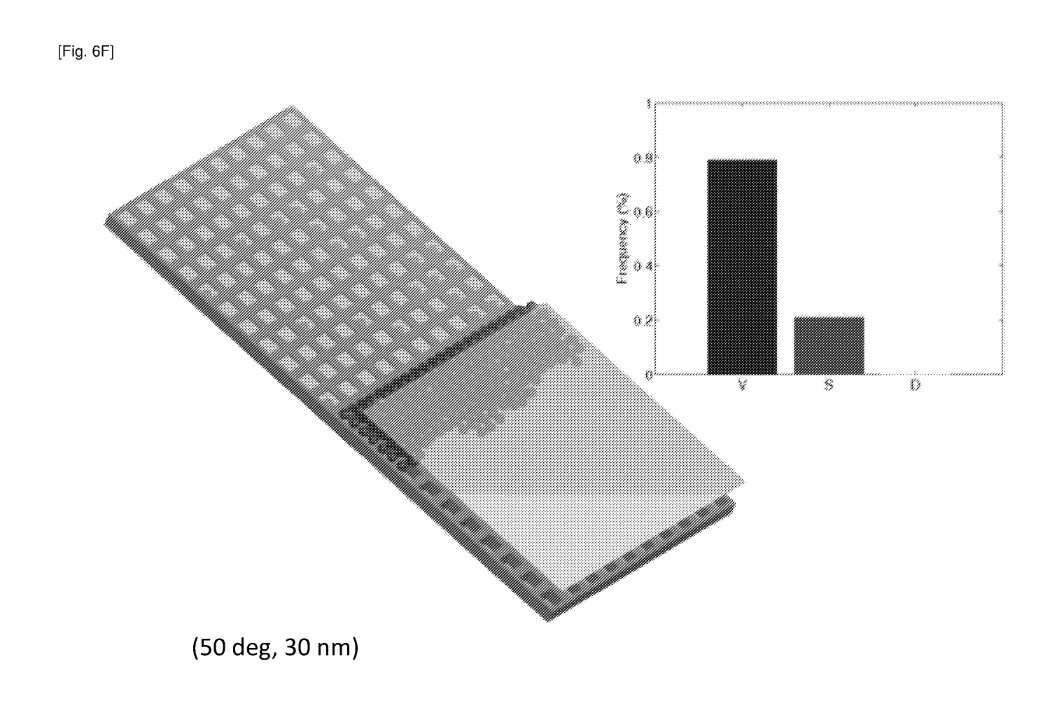

FIGS. 6A to 6F illustrate the progression results of Brownian dynamics simulations of the directed self-assembly of nanoparticles of the present invention and show the importance of the formation of a thin film in order to better control the Brownian motion of the nanoparticles within the monolayer. FIGS. 6A to 6F show how contact angle varies from 10, 30 to 50 degrees for film thicknesses of 15 nm and 30 nm for self-assembly of 8-9 nm gold nanoparticles. The histograms in FIGS. 6A to 6F show the percentage of vacancies (V), single particles per cavity (S) and double particles per cavity (D).

FIGS. 6A to 6F show the results of achieving a low thin film thickness relative to the diameter of the nanoparticles within the thin film. FIGS. 6A to 6F show that overall, the lower the thin film thickness relative to the nanoparticle diameter, the lesser the resultant defects (V and D). The thin film thickness is about 1.67-1.875 times the diameter of the nanoparticles in the thin films in FIGS. 6A to 6C, and about 3.33-3.75 times the diameter of the nanoparticles in the thin films in FIGS. 6D to 6F. It is shown that the methods of FIGS. 6A to 6C, which have lower thin film thickness relative to the nanoparticle diameter than FIGS. 6D to 6F, have less defects (V and D) when compared to the methods of FIGS. 6D to 6F. FIGS. 6A to 6F also show that less defects may result when the substrate is at a higher contact angle as long as low thin film thickness relative to nanoparticle diameter is maintained. Therefore, it is shown that the ability to control of the Brownian motion of the nanoparticles through the formation of the thin film may advantageously reduce the number of defects on the resulting deposited substrate.

### EXAMPLES

Non-limiting examples of the invention and a comparative example will be further described in greater detail by reference to specific Examples, which should not be construed as in any way limiting the scope of the invention.

### Materials

Hydrogen Silsesquioxane (HSQ): Supplied by Tat Lee Engineering Pte Ltd (Singapore)

Silicon and silicon nitride substrates: Supplied by Silicon Valley Microelectronics, Inc.

Hexane: Supplied by Sigma Aldrich.

### Example 1—Template Fabrication

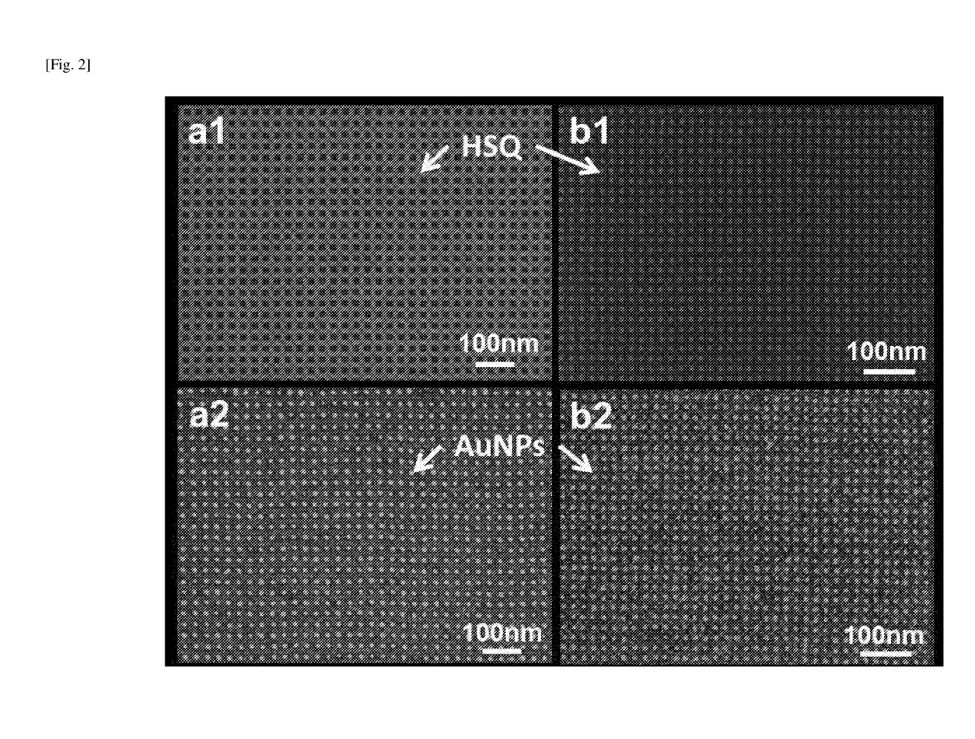

A topographical template based on nanoholes, nanopillars or nanogratings is first fabricated. The template may be fabricated with any existing top-down patterning techniques such as electron beam lithography, focused ion beam or nanoimprint. In one embodiment, a topographical template based on nanoholes, nanopillars or nanogratings was fabricated by patterning a 20 nm thick film of hydrogen silsesquioxane (HSQ) (supplied by Tat Lee Engineering Pte Ltd (Singapore)) negative tone resist on a silicon or silicon nitride substrate (supplied by Silicon Valley Microelectronics, Inc.), using a 100 keV electron beam lithography system (EBL). The sample was developed for 1 minute in aqueous solution of 1% NaOH and 4% NaCl, followed by rinsing in deionized water for 1 minute and blow drying with a nitrogen gun. Samples were treated for 5 minutes in a UV ozone cleaner before use in the DSA-n process. FIG. 2(a1) shows square nanoholes fabricated by electron beam lithography using HSQ resist, and FIG. 2(a2) shows nanopillars fabricated by electron beam lithography using HSQ resist.

### Example 2 —Spreading-Mediated Self-Assembly Process

### Example 2a—Synthesis of Gold Nanoparticles

Gold nanoparticles (AuNPs) with uniform sizes were prepared using organic amines both as size control reagents and reducing reagents. In a typical synthesis, 50 mg of HAuCl₄ was dissolved in 5 mL of oleylamine (OA), together with 5 mg of octa-ammonium polyhedral oligomeric silsesquioxane (OA-POSS), which increased the reaction rate while simultaneously achieving a narrow distribution of particle sizes. The reaction mixture was then ultrasonicated for 15 minutes to achieve a homogeneous orange solution that was next transferred to a reaction flask equipped with a nitrogen gas inlet and condenser. Under a nitrogen environment, the reaction temperature was increased to 80° C. and maintained for 3 hours. During this time, a gradual color change from orange to colorless to pink, and finally to red was observed. Particle purification was accomplished by repeated centrifugation of the solution: the reaction mixture was first diluted with hexane in a 50/50 volume ratio, followed by addition of ethanol to precipitate the particles. The precipitate was then centrifuged for 10 minutes and the centrifuge pellet was redispersed into hexane. This process was repeated three times to remove free OA and OA-POSS. The solvent (hexane) was removed from the supernatant by rotary evaporation and the residue was checked for the success of purification using Fourier transform infrared spectroscopy (FTIR). Purified AUNPs were then redissolved in hexane.

### Example 2b—General Process

A sample containing the template as prepared by Example 1 was brought into contact with a suspension bath of 8-9 nm diameter gold nanoparticles as prepared by Example 2a suspended in hexane solvent, with only the bottom edge of the sample in contact with the liquid surface. Upon contact, a micro-meniscus was formed between the sample and liquid (FIG. 1a).

A closed system comprising the suspension bath and sample was maintained to create a hexane-rich environment. This environment induced the formation of a thin liquid film that immediately started climbing up the substrate surface due to the surface tension gradient taking place at the film interface, the evaporation of hexane as well as the local variation of densities of gold nanoparticles (FIG. 1b). The film length L(t), measured as the distance between the advancing edge to the surface of the suspension bath, has a square-root dependence on time (t). In other words, the film length L(t) advances in time (t) as a function of L(t)˜√t. As the particles continuously diffused from the bath to the film, the sample was kept in contact with the bath for at least one hour to ensure a sufficient density of gold nanoparticles within the film to cover the entire free space allocated within the template.

Next, the sample was raised above the bath interface and left in the hexane-rich environment to dry out for 30 minutes. As depicted in FIG. 1(d), the film immediately started thinning due to uniform evaporation of hexane which confined the particles into a monolayer.

As shown in FIG. 1(e), a nano-meniscus pushing the particles into the template cavities was then formed while the film was drying out. A straight line propagating from the bottom of the sample all the way to the top edge was revealed. Further, as shown in FIG. 1(f), a final ordered structure according to the guiding template was obtained, wherein the nanoparticles were positioned individually into the pre-defined space on the template. The photographs accompanying the illustrations were taken at different ages of the process and shows the evolution of the spreading film on the sample surface.

### Example 2c—Process Using Template With Nanosquare Holes and Template With Nanopillar Holes

The spreading-mediated directed self-assembly technique allows for the achievement of sub-10 nm single particles positioning within different templates with remarkably high reproducibility. SEM images of two templates consisting of nanosquare holes and nanopillar holes patterned by electron beam lithography in a 20 nm thick HSQ film are shown in FIG. 2(a1) and FIG. 2(b1) respectively. FIG. 2(a2) and FIG. 2(b2) show the corresponding SEM images after performing the spreading-mediated directed self-assembly process of Example 2a using 8-9 nm diameter gold nanoparticles. As shown in FIG. 2(a2) and FIG. 2(b2), a defect-free monolayer of nanoparticles was obtained which were positioned individually in each allocated space within the template. As can be seen in FIG. 2, the method of the present invention may advantageously be capable of positioning sub-10 nm particles via self-assembly and with single particle resolution. Further advantageously, the method of the present invention may not result in the formation of a double layer and may be defect free.

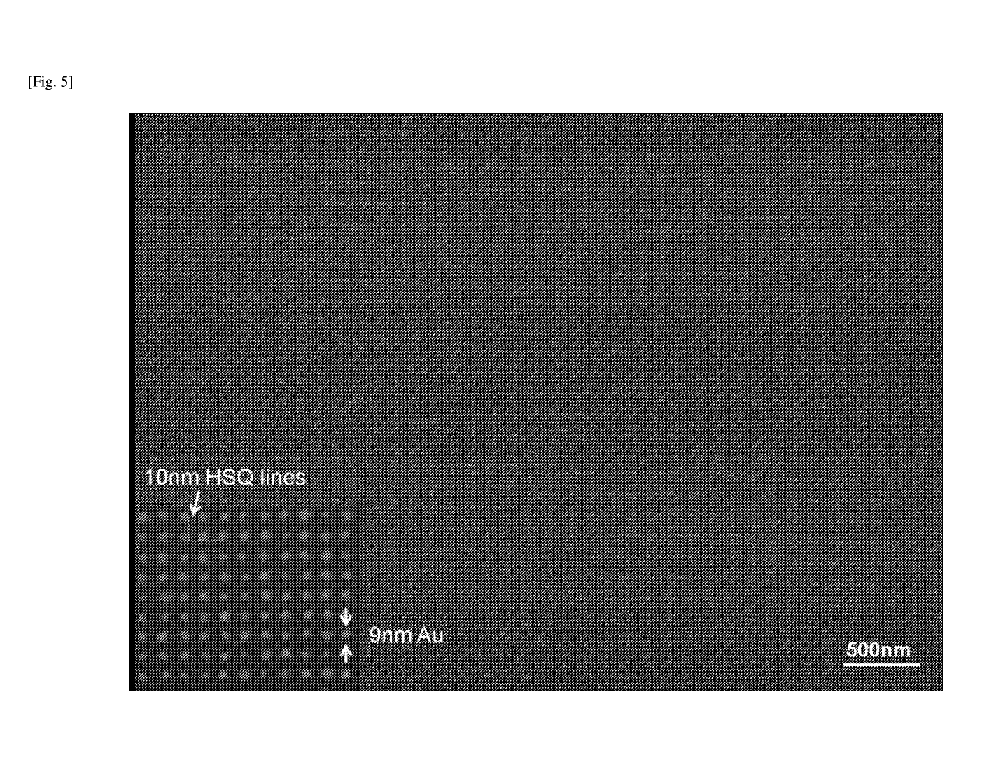

Further as shown in FIG. 5, the present inventors have successfully demonstrated that the present technique can perform directed self-assembly of gold nanoparticles with single particle resolution over large area. A prototype of the large sample is shown on a SEM image in FIG. 5. The sample consists of a nanosquare hole template fabricated by electron beam lithography by exposing a 20 nm thick HSQ resist, and the holes were filled with 8-9 nm gold nanoparticles using the spreading-mediated directed self-assembly technique of Example 1a. As demonstrated in FIG. 5, perfect assembly of the particles within the template cavities was achieved that was relatively defect-free. This thus demonstrates the immense potential of this technique to pattern at sub-10 nm resolution over a large area.

### Comparative Example

In comparison with the other methods such as Langmuir-Blodgett, drop-coasting, dip-coating or spin-coating, the present method advantageously does not result in the formation of a double layer and may be defect-free.

### Langmuir-Blodgett Method

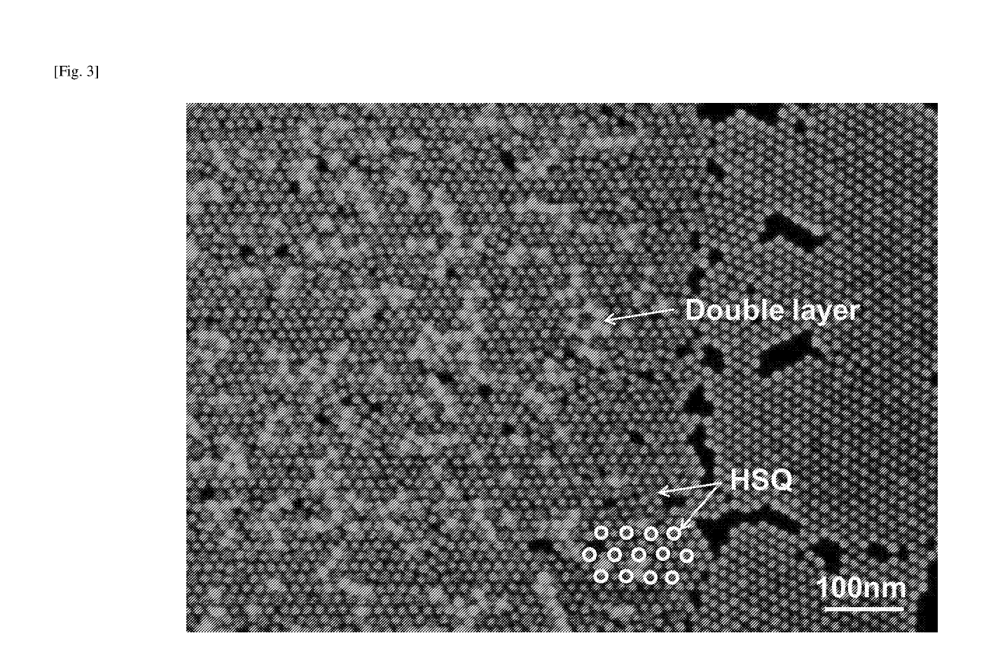

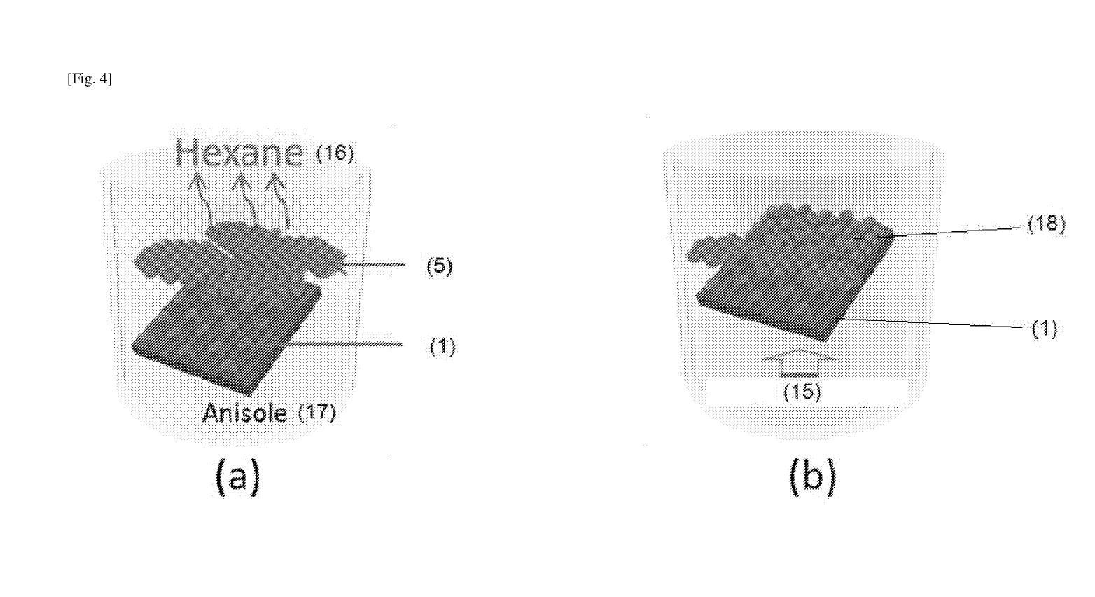

As shown in FIG. 3, a silicon sample with 10 nm diameter HSQ pillars was used to guide 9 nm gold nanoparticles in a hexagonal lattice. This sample was obtained by using the Langmuir Blodgett method to form a monolayer of particles on top of anisole prior to its transfer to the template as illustrated in FIG. 4. FIG. 4 illustrates the Langmuir-Blodgett method. First, a topographical template (or substrate) (1) was immersed in a liquid phase (17), such as anisole. A few droplets of suspension were then added and the solvent was allowed to evaporate (16), leaving a film of nanoparticles floating on the surface of the liquid phase. The substrate was then pulled out through the nanoparticle film (15), thereby depositing the nanoparticles on the substrate (18). However the presence of template structures on the substrate may cause defects (such as a non-monolayer arrangement) in the deposited nanoparticle layer due to the template structures already occupying some space on the substrate.

As shown in FIG. 3, excess particles formed a double layer atop the HSQ pillars. In addition, inevitable cracks emerged on the film while being transferred to the substrate due to mechanical disruptions. These defects are common for transfer techniques in which a self-assembled monolayer is transferred onto a template, which limits their compatibility with directed self-assembly using topographical templates. In contrast, the method of the present invention may advantageously not result in the formation of a double layer and may be defect free.

Further in contrast, the present method is based on spreading a thin film of colloidal suspension on a substrate prior to the deposition of nanoparticles. The thickness of this film is defined by the solvent density as well as the size of the particles, which allows the particles to spread evenly on the substrate surface to achieve the ideal coverage.

In contrast to existing methods of using a pre-packed monolayer to feed the template (in which close-packed particles are limited in movement to avoid the formation of double layer prior to transfer onto template), the present method advantageously allows the particles to reorganize within the thin film which avoids them from getting trapped within a double layer as the film dried out.

As demonstrated in FIG. 2, the present method may perform directed self-assembly of sub-10 nm particles with single-particle resolution. The individual control offered by this method over the particles is unprecedented and may enable directed self-assembly within both periodic and non-periodic templates over a large area. Other methods which are already limited when using periodic templates face even more challenges when using non-periodic templates. In general, when the area occupied by the template structures is much larger than the free space allocated for the particles, the formation of an even denser double layer may result, thus reducing the area of defect-free self-assembled nanoparticles.

This is contrast to the present invention. As shown in FIG. 5, the present inventors have successfully demonstrated that the present technique can perform directed self-assembly of gold nanoparticles with single particle resolution over large area.

### INDUSTRIAL APPLICABILITY

The method of the present invention may be able to position sub-10 nm particles via self-assembly. The method of the present invention may be able to position sub-10 nm particles with single particle resolution via self-assembly. The method of the present invention may not result in the formation of a double layer and may be defect-free.

The method of the present invention may enable self-assembly within both periodic and non-periodic templates over a large area. Moreover, periodic and non-periodic structures may be simultaneously obtained on the same substrate allowing the fabrication of complex nanostructures and patterns.

The method of the present invention may be a simple process that is cost-effective with potential for mass production.

The method of the present invention may produce defect-free materials.

The method of the present invention may allow for the use of active materials (e.g. quantum dots, magnetic nanoparticles, plasmonic materials) without further fabrication steps.

The composite material produced by the method of the present invention may be used in fabricating functional devices:

### Nano Patterning

Fabricating nanostructures at very high densities with sub-10 nm pitch over large areas is currently impossible with conventional lithographic techniques. For instance, the resolution of electron-beam lithography is significantly affected by proximity effects at sub-10 nm pitch, particularly at high densities. The method of the present invention may have directed self-assembly capability and the capability to position particles side-by-side separated only by the length of a ligand (about 2 nm). In addition, the particles may comprise or consist of functional materials (e.g. semiconductor, magnetic, conductive or plasmonic properties).

### Magnetic Bit-Patterned Media

The hard disk industry is striving to develop a robust technique for patterning magnetic bits with densities up to 10 Tbit/in². This is a highly challenging goal for precision in positioning while maintaining uniformity in structures across the area. This cannot be achieved with conventional methods as they involve patterning and etching steps which degrade the final structures. In contrast, the method of the present invention may be used directly to manipulate the packing of magnetic nanoparticles.

### Flash Memories

Conventional flash memories are based on charge storage within a thin oxide film called a “floating gate” which is separated by a tunnel junction from the silicon wafer called a “channel”. Any damage into the tunnel junction such as small hole will allow the floating gate to discharge and lose the stored information. However, if the floating gate is made of nanoparticles to store the charges, then only the particles situated at the damaged region will be discharged and the remaining particles will still retain their charges and continue working normally. Consequently, the method of the present invention could drastically improve the lifetime of flash memories.

### Single-Electron Transistors (SETs)

In order to reduce power consumption and increase the speed of the integrated circuits, the semiconductor industry is developing single-electron transistors. A device comprising of a nanoparticle sandwiched between a couple of electrodes is extremely challenging to fabricate. For the electron to tunnel between the electrodes through the particle efficiently, the nanoparticle needs to be as small as 2 nm in diameter and particle-to-be-electrode separation must be smaller than 1 nm. Currently, existing lithographic patterning methods are unable to fabricate such a device. However, the method of the present invention has a high chance to be successful in positioning single particles between the prefabricated electrodes.

### Plasmonic Devices

The method of the present invention may be employed for nano-LED and plasmonic devices utilizing charge interaction between nanoparticles. The present method enables the positioning of particles within many different configurations, which can lead to the excitation of different plasmonic modes in plasmon-based devices.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of producing a composite material comprising a substrate and a monolayer of nanoparticles self-assembled thereupon, the method comprising:
(i) providing a suspension comprising a solvent and nanoparticles dispersed therein;
(ii) providing a substrate comprising a surface with void spaces for accommodating said nanoparticles;
(iii) contacting one end of said substrate with said suspension in a closed system, to thereby gradually dispose said suspension over said substrate by capillary action, thereby forming a film of suspension on said substrate; and
(iv) allowing evaporation of said film of suspension, thereby forming a monolayer of nanoparticles self-assembled in said void spaces on said surface of the substrate.

2. The method according to claim 1, wherein the closed system comprises (i) the suspension comprising a solvent and nanoparticles dispersed therein; (ii) the substrate comprising a surface with void spaces for accommodating said nanoparticles; and (iii) an atmosphere comprising evaporated solvent.

3. The method according to claim 1, wherein (iii) contacting one end of the substrate forms a meniscus between the substrate and suspension, said meniscus having an edge where the surface of the substrate and the suspension meet, wherein the suspension is gradually disposed onto the substrate when the edge of the meniscus moves relative to the substrate, thereby forming a thin film of suspension on said substrate.

4. The method according to claim 1, wherein the substrate is withdrawn from the suspension prior to step (iv).

5. The method according to claim 1, wherein (iv) evaporation of the film of suspension forms a meniscus between the substrate and suspension, said meniscus having an edge where the surface of the substrate and the suspension meet, wherein the monolayer of nanoparticles self-assembled in the void spaces is formed when the edge of the meniscus moves relative to the substrate and pushes the nanoparticle(s) into a void space.

6. The method according to claim 1, wherein each void space accommodates one nanoparticle.

7. The method according to claim 1, wherein the nanoparticles have a diameter of about 1 nm to about 20 nm.

8. The method according to claim 1, wherein the nanoparticles have a diameter of less than 10 nm.

9. The method according to claim 1, wherein the length, width and/or depth of each void space on said substrate is about 1.1 to about 1.9 times the average diameter of the nanoparticles.

10. The method according to claim 1, wherein the length of the filled space between each void space is in the range of at least 1 nm.

11. The method according to claim 1, wherein the nanoparticles are selected from the group consisting of carbon nanoparticles, silica nanoparticles, metal nanoparticles, gold nanoparticles, silver nanoparticles, copper nanoparticles, platinum nanoparticles, palladium nanoparticles, ruthenium nanoparticles, iron nanoparticles, titanium nanoparticles, nickel nanoparticles, or rhenium nanoparticles, metal oxide nanoparticles, zinc oxide nanoparticles, quantum dots, magnetic nanoparticles, and plasmonic materials.

12. The method according to claim 1, wherein the void spaces on the substrate are selected from the group consisting of nanoholes, the space between nanopillars, the space between nanogratings, the space between nanochannels, and combinations thereof.

13. The method according to claim 1, wherein the void spaces on the substrate are produced using lithography.

14. The method according to claim 1, wherein the substrate is selected from the group consisting of Si, Si₃N₄, SiO₂, insulators, semiconductors, glasses, polymers, and metals.

15. The method according to claim 1, wherein the solvent is selected from the group consisting of organic solvents, alcohols, ethanol, aliphatic hydrocarbons, glycol ethers, chlorofluorocarbons, chlorocarbons, benzene, methylene chloride, perchloroethylene, formaldehyde, triethyleamine, toluol, acetaldehyde, pentane, hexane, toluene, benzene, ether, 1,2-dichlorobenzene, acetone, dichloromethane, ethylacetate and combinations thereof.

16. The method according to claim 1, wherein the substrate is Si, Si₃N₄, or SiO₂; the suspension comprises hexane solvent and gold nanoparticles of less than 10 nm diameter dispersed therein; and a substrate comprising a surface with void spaces having a length and depth of about 10 nm.

17. A method of producing a composite material comprising a substrate and a monolayer of nanoparticles self-assembled thereupon, the method comprising:
(i) providing a suspension comprising a solvent and nanoparticles dispersed therein;
(ii) providing a substrate comprising a surface with void spaces for accommodating said nanoparticles;
(iii) contacting one end of said substrate with said suspension in a closed system, to thereby gradually dispose said suspension over said substrate by capillary action, thereby forming a film of suspension on said substrate; and
(iv) allowing evaporation of said film of suspension, thereby forming a monolayer of nanoparticles self-assembled in said void spaces on said surface of the substrate, wherein each void space accommodates one nanoparticle.

18. A composite material produced by a method according to claim 1.
